(19) United States
(12) Patent Application Publication
(10) Pub. No.: US 2011/0006012 A1
(43) Pub. Date: Jan. 13, 2011

(54) Method for Decomposing Oil and Other Organic Insoluble and Semi-Soluble Liquids in an Aqueous Medium

(75) Inventors: Clive Edward Hall, Middlesex (GB); Keith William Dawes, Berkshire (GB)

Correspondence Address: GOMEZ INTERNATIONAL PATENT OFFICE, LLC, 1501 N. RODNEY STREET, SUITE 101, WILMINGTON, DE, 19806, US

(73) Assignee: WINDSOR SCIENTIFIC LIMITED, Berkshire (GB)

(21) Appl. No.: 12/523,992

(22) PCT Filed: Dec. 17, 2007
(86) PCT No.: PCT/IB2007/055175

§ 371 Date: Jul. 21, 2009

(30) Foreign Application Priority Data
Dec. 21, 2006 (GB) 0625579.8

(51) Int. Cl. C02F 1/36; C02F 1/46

(52) U.S. Cl. 210/721; 204/222

(57) ABSTRACT

A method of decomposing an organic liquid, having a solubility in water of 0 or less than 50 g/l at 25° C., comprising: a) emulsifying an amount of the organic liquid in an amount of an aqueous medium to form an emulsion of the organic liquid in the aqueous medium; and b) electrochemically decomposing the emulsified organic liquid on a surface of an oscillating electrode in an electrochemical cell, wherein the electrode is oscillating at a frequency of at least 5 KHz.

The present invention concerns a method useful for decomposing an insoluble or semi-soluble organic liquid, such as oil, in an aqueous medium. In particular, though not exclusively, the present invention concerns the use of a combination of electrochemical oxidation and ultrasound for the decomposition of water-insoluble and semi-soluble organic materials dispersed in an electrically conductive liquid medium into predominantly CO₂ and H₂O.

It is known that electrochemical oxidation processes can be utilised to decompose organic materials in liquid media, whereby an electrochemical reaction generates oxidising species in the media, such as atomic oxygen and hydroxyl radicals, which are able to subsequently oxidise the organic waste species to form water, carbon dioxide and other decomposition products. Previously disclosed processes appear to only work with water-soluble compounds, require the addition of heat, the use of a redox system in the electrolyte and/or are difficult to use in situations where the electrode surfaces become blocked by deposits in the aqueous media or from reaction products formed during the oxidation process.

WO-A-02062709 (Fletcher et al.) discloses an electrochemical oxidation method and apparatus for treating organic waste whereby said waste matter is added periodically to an acidic aqueous electrolyte containing silver ions as the primary oxidising species. The water-soluble organic waste is decomposed via an oxidation process concurrent with reduction of the primary oxidising species. Anodic re-oxidation of the primary oxidising species is driven by an applied electrical potential between the anode and cathode, allowing further oxidation of the organic waste. Insoluble organic waste is separated from the electrolyte and destroyed by a heat treatment step in which the temperature is raised to at least 518° C. for a period of 15 minutes.

WO05028372 (Carson et al.) discloses an electrochemical oxidation apparatus and an electrochemical oxidation process mediated by the addition of at least one redox couple to an electrolyte, wherein the oxidised form of said couple(s) are produced by oxidation at the anode. The oxidised species of said redox couple(s) oxidise the organic waste matter, themselves being converted to their reduced form, whereupon they are reoxidised at the anode surface). Ultrasound may be used to assist the mediated electrochemical oxidation reaction by increasing the contact between the redox species and the organic materials.

It is the object of the present invention to overcome one or more of the disadvantages associated with the methods described within the prior art and to provide an improved method for the decomposition of water insoluble and semi-soluble organic liquid wastes.

In accordance with the present invention, there is provided a method of decomposing an organic liquid, having a solubility in water of 0 or less than 50 g/l, preferably less than 5 g/l, more preferably less than 0.5 g/l, even more preferably less than 0.05 g/l, at 25° C., the method comprising the following sequential or concurrent steps:
a) emulsifying an amount of the organic liquid in an amount of an electrically conducting aqueous medium to form an emulsion of the organic liquid in an electrically conducting aqueous medium; and
b) electrochemically decomposing the emulsified organic liquid on a surface of an oscillating electrode in an electrochemical cell, wherein the electrode is oscillating at a frequency of at least 5 KHz, preferably at least 15 KHz, more preferably at least 20 KHz. The electrode is preferably oscillated at no more than 100 KHz, more preferably no more than 80 KHz, e.g. no more than 50 KHz.

The electrode is preferably oscillated at an ultrasonic frequency i.e. 15 to 100 KHz. The electrode may be oscillated by means of an ultrasonic transducer which is mechanically or hydrodynamically coupled to the electrode. Preferably, the electrode is oscillated at a frequency of from about 20 KHz to about 80 KHz, such as from about 20 to about 50 KHz.

The oscillating electrode provides an energy density at the surface of the oscillating electrode. This energy density is preferably sufficient to cause cavitation of the emulsified organic liquid. Cavitation at the electrode surface will depend upon the frequency of oscillation and viscosity of the medium in the electrochemical cell. For example, depending upon the particular medium in the electrochemical cell, when the electrode is oscillated at an ultrasonic frequency of 20 KHz, an energy density at the surface of the electrode of above 0.5 Wcm⁻², e.g. up to 1 Wcm⁻² or above, will typically be required to cause cavitation.

The mechanism of decomposition of the organic liquid may be oxidative or reductive, depending upon whether the liquid contacts the anode or the cathode of the electrochemical cell.

The aqueous medium is preferably an aqueous salt solution. An example of such a salt is sodium chloride. Salt concentrations in the solution are preferably higher than 0.1 millimolar, more preferably higher than 1 millimolar, even more preferably higher than 0.01 molar, yet more preferably 0.1 molar, e.g. 1 molar.

In one embodiment of the present invention, the organic liquid and aqueous medium may be mixed together in the electrochemical cell and the mixture subjected to high shear conditions to disperse the organic liquid in the aqueous medium. The oscillating electrode provides an energy density at the surface of the oscillating electrode sufficient to emulsify the organic liquid in the aqueous medium e.g. such that steps a) and b) occur concurrently.

In another embodiment of the present invention, the organic liquid and aqueous medium may be emulsified prior to subjecting to it electrochemical decomposition e.g. such that steps a) and b) occur sequentially. In this embodiment, the emulsified organic liquid may also be subjected to mixing conditions in the electrochemical cell. The inventors speculate, though they do not wish to be limited by this, that the oscillating electrode could provide an energy density at the surface of the oscillating electrode sufficient to subject the emulsified organic liquid to continued or enhanced emulsifying conditions.

The method of the present invention may be carried out at room temperature, e.g. 20-25° C., although the process may take place at elevated temperatures e.g. due to heating from use of the apparatus.

Whilst the Applicant does not wish to be bound by theory, it is believed that the decomposition of the organic liquid takes place by the direct contact of the organic liquid with the electrode surface. Accordingly, the method of the present invention does not essentially require the addition of a separate redox couple. Indeed, the method of the present invention preferably occurs in the absence of a redox couple.

The organic liquid may comprise one or more organic compounds which is/are liquid at the temperature of emulsification, or it may contain a plurality of organic compounds in a form which is liquid at the temperature of emulsification e.g. an organic compound, which is per se solid at the temperature of emulsification, dissolved in an organic solvent.

Ultrasonic transducers are capable of producing high frequency sound waves, typically between about 5 to about 100 KHz, although more usually between about 20 to about 80 kHz. When introduced into a liquid, ultrasonic waves can cause the formation, growth and implosive collapse of bubbles within said liquid, a process termed cavitation. During cavitational collapse liquid energy is focused into minute volumes, producing intense local heating, high pressures and rapid heating and cooling rates. The exposure of high powered ultrasound to both the electrode surface or surfaces in the electrochemical cell and to the organic liquid provides sufficient energy to cause emulsification of the substantially insoluble organic liquids in the aqueous medium, allowing efficient mass transport of said organic liquids to the electrode surface, thereby enabling the electrochemical decomposition process to occur efficiently.

Whilst the process of cavitation can be demonstrated to have a beneficial effect on the electrochemical decomposition of organic insoluble and semi-soluble liquids, the process can cause a great deal of vibration resulting in component damage and an overall loss of efficiency within the electrochemical redox system. Unlike other known materials, the inventors have found that diamond electrodes can withstand high power ultrasound without suffering from damage resulting from cavitation. This resilient property of diamond electrodes can allow the application of ultrasound to both the electrode surface and to the surrounding liquid, enabling maximum organic waste emulsification and so increasing the probability of contact between the organic liquid with the electrode surface, without causing cavitation damage to the electrode structure. Diamond per se has poor electrical conductivity properties, but can be modified e.g. by doping with boron, such that the diamond electrode possesses electronic properties similar to that of a semi-metal. Boron doped diamond electrodes may have sufficiently high electrical conductivities that are resilient to cavitational damage when subjected to high powered ultrasonic waves. Diamond electrodes can be used either cathodically or anodically and as such the polarity of each electrode can be periodically reversed in order to clean the electrode surfaces, maintaining the efficiency of the electrochemical decomposition process. Diamond electrodes suitable for use in the present invention are commercially available from e.g. Windsor Scientific Limited, England.

The efficiency of the electrochemical decomposition processes can be reduced by a build up of deposits e.g. from the emulsion or from the reaction products of the electrochemical reaction on the surface of the electrodes. However, the use of the ultrasound tends to reduce the likelihood of build up of such deposits.

The method of the present invention can be utilised at room temperature and lends itself to simple process control and long term, unattended operation. Thus this method is well suited for tasks such as the decomposition of dangerous or contaminated organic chemicals and oil,

In another aspect, the present invention provides an apparatus suitable for use in the above described method. The apparatus comprises an electrochemical cell comprising a diamond electrode, preferably a boron doped electrode, coupled to an ultrasonic transducer for oscillating the diamond electrode at a frequency of at least 20 KHz.

1. A method of decomposing an organic liquid, having a solubility in water of 0 or less than 50 g/l at 25° C., the method comprising the following sequential or concurrent steps:
a. emulsifying an amount of the organic liquid in an amount of an aqueous medium to form an emulsion of the organic liquid in the aqueous medium; and
b. electrochemically decomposing the emulsified organic liquid on a surface of an oscillating electrode in an electrochemical cell, wherein the electrode is oscillating, at a frequency of at least 5 KHz.

2. A method as claimed in claim 1, wherein the electrode is a diamond electrode, preferably a boron-doped diamond electrode.

3. A method as claimed in claim 1, wherein the electrode is oscillated by means of an ultrasonic transducer which is mechanically coupled to the electrode.

4. A method as claimed in claim 1, wherein the electrode is oscillated by means of an ultrasonic transducer which is hydrodynamically coupled to the electrode.

5. A method as claimed in claim 1, wherein the electrode oscillated at a frequency of from about 20 to about 80 KHz, such as from about 20 to about 50 KHz.

6. A method as claimed in claim 1, wherein the organic liquid has a solubility in water of 0 or less than 5 g/l, preferably less than 0.5 g/l, more preferably less than 0.05 g/l at 25° C.

7. A method as claimed in claim 1, wherein the oscillating electrode provides an energy density at the surface of the oscillating electrode sufficient to cause cavitation of the emulsified organic liquid.

8. A method as claimed in claim 1, wherein the oscillating, electrode provides an energy density at the surface of the oscillating electrode sufficient to emulsify the organic liquid in the aqueous medium, such that steps a. and b. occur concurrently.

9. A method as claimed in claim 1, wherein steps a. and b. occur sequentially and wherein the oscillating electrode provides an energy density at the surface of the oscillating electrode sufficient to maintain or enhance emulsifying conditions in the electrochemical cell.

10. Apparatus suitable for use in a method for the decomposition of an organic liquid having a solubility in water of 0 or less than 0.05 g/l at 25° C. as claimed in any one of the preceding claims, comprising an electrochemical cell comprising a diamond electrode, preferably a boron doped electrode, coupled to an ultrasonic transducer for oscillating the diamond electrode at a frequency of at least 20 KHz.
